(19) United States
(12) Patent Application Publication
(10) Pub. No.: US 2010/0129022 A1
(43) Pub. Date: May 27, 2010

(54) ROLLING BEARING CAGE COMPOSED OF A PLURALITY OF PARTS

(75) Inventors: Berthold Beyfuss, Kaisten (DE); Hans-Jürgen Friedrich, Konigsberg (DE); Fred Fuchs, Schweinfurt (DE); Alfred Radina, Poppenlauer (DE); Jonas Schierling, Hassfurt (DE)

Correspondence Address: BUCHANAN, INGERSOLL & ROONEY PC, POST OFFICE BOX 1404, ALEXANDRIA, VA, 22313-1404, US

(73) Assignee: AB SKF, Goteborg (SE)

(21) Appl. No.: 12/598,008

(22) PCT Filed: Apr. 25, 2008
(86) PCT No.: PCT/EP08/03359

§ 371 Date: Jan. 6, 2010

(30) Foreign Application Priority Data
Apr. 28, 2007 (DE) 10 2007 020 113.5

(51) Int. Cl. F16C 33/46

(52) U.S. Cl. 384/577

(57) ABSTRACT

A rolling bearing cage has at least U-shaped limited pockets for rolling bodies. In the rolling cage, the U-shaped delimitation of one of the pockets is configured by the bonded connection of two web elements on an annular circumferential element, the circumferential element is free of cavities and penetrations for a complete connection to sections of the web elements, and the elements are configured to have a shape adapted to each other for placing the elements in the intended position for the bonded connection such that the positions of the web elements on the circumferential element is predetermined in the circumferential direction and/or in the axial direction of the circumferential element.

### TECHNOLOGICAL FIELD

The invention relates to a rolling bearing cage with pockets bordered at least in a U-shape for rolling bodies.

### BACKGROUND DISCUSSION

For example, DE 79 35 982 U1 discloses a rolling bearing cage which consists of two side parts and a plurality of separately manufactured web parts connected by welding or the like to the side parts, the web parts forming between themselves pockets for holding the rolling bodies. Here the side parts and web parts are made of flat-rolled or profile-rolled wire and the web parts are embossed for formation of stop surfaces for the rolling bodies.

### SUMMARY

One object of this invention is to devise an improved rolling bearing cage with pockets bordered at least in a U-shape for rolling bodies, which cage can be produced especially precisely but also easily and thus economically.

A rolling bearing cage with pockets bordered at least in a U-shape for rolling bodies includes the following features:
The U-shaped boundary of one of the pockets is formed by bonded connection of two web elements on a ring-like peripheral element,
the peripheral element is free of cavities and penetrations for a fully peripheral connection to the sections of the web elements and
for proper positioning of the elements to one another for a bonded connection, the elements are made with a shape matched to one another such that the positions of the web elements on the peripheral element are predetermined in the peripheral direction and/or in the axial direction of the peripheral element.

The subject matter of this invention is based on the finding that relative to the initially described rolling bearing cage according to DE 79 35 982 U1 the positions of the web elements on the peripheral element in the peripheral direction and/or in the axial direction of the peripheral element are predetermined by the indicated matched shaping of the elements in the corresponding assembly of the elements for bonded connection of the elements by the indicated shaping, so that as an inherent consequence of the indicated shaping the given geometry of the cage is exactly and easily maintained. In this respect, for the rolling bearing cage as claimed in DE 79 35 982 U1 positioning of the parts which are to be connected to one another is not supported by the shaping of the parts so that positioning within the framework of a welding process of the parts must be ensured. In this respect, for this invention the indicated process for connecting the elements to one another is relieved at least partially so that compared to DE 79 35 982 U1 the cage can be produced more easily, more quickly and thus more economically. Furthermore the invention is based on the finding that for positioning of the elements to one another, not as known from the prior art, it is necessary to make the peripheral element with cavities or penetrations into which the correspondingly made axial ends of the web elements are designed for insertion. Because the peripheral element as claimed in the invention is free of cavities and penetrations for a fully peripheral connection to sections of the web elements, the peripheral element can be in turn produced comparatively easily, quickly and thus economically. Here on the peripheral element for example bulges in the radial direction or recesses which extend in the axial direction are sufficient to advantageously ensure both the indicated positioning and also a sufficiently fixed connection between the elements. Of course the roller bearing cage as claimed in the invention compared to rolling bearing cages which are machined out of a hollow cylinder-like blank also offers the advantage that waste material is not formed by machining especially the cage pockets and thus advantageously material is saved compared to these methods.

In one advantageous configuration the peripheral element on the one hand and the web elements on the other are made with different properties. Thus it is advantageously possible to pair different materials and for example depending on the application to produce less loaded elements from more economical material. Furthermore it is also possible to make one of the elements for high wear resistance from heat treated steel and to leave the other elements, for example for high toughness, untreated.

In another advantageous configuration it is possible to make at least one of the elements coated. As a result of assembly of the rolling bearing cage from peripheral and web elements it is much simpler and thus also more economical to undertake only coating of individual elements, for example the web elements. The corresponding applies to another advantageous configuration in which on the surfaces of the web elements facing the rolling bodies for example impressions which are made droplet-shaped are provided in operation as lubricating pockets. Here the lubricating pockets can be arranged in one embodiment in the left axial half of the web element obliquely according to a line which runs from the right rolling bearing cage region obliquely to the center point of the rolling bearing and are made accordingly mirror-inverted in the right half.

### BRIEF DESCRIPTION OF THE DRAWING FIGURES

Other advantages, features and details of the invention will become apparent from the embodiments of the invention described below using the figures:

FIGS. 1 and 2 in a perspective view show a cylindrical roller bearing cage with two peripheral elements with indentations for web elements with a uniform trapezoidal cross section in the connected and unconnected state of the elements,

FIGS. 3 and 4 in a perspective view show a cylindrical roller bearing cage with two peripheral elements with bulges for web elements with a uniform trapezoidal cross section in the connected and unconnected state of the elements,

FIGS. 5 and 6 in a perspective view show a cylindrical roller bearing cage with two peripheral elements with indentations for web elements with axial ends reinforced in the manner of a hammer head in the connected and unconnected state of the elements,

FIGS. 7 and 8 in a perspective view show a cylindrical roller bearing cage with two ring-like peripheral elements with end-side, rectangle-like recesses for web elements with a uniform trapezoidal cross section in the connected and unconnected state of the elements,

FIGS. 9 and 10 in a perspective view show a cylindrical roller bearing cage with two ring-like peripheral elements with end-side, rectangle-like recesses for web elements with axial ends reinforced in the manner of a hammer head in the connected and unconnected state of the elements,

FIGS. 11 and 12 in a perspective view show a cylindrical roller bearing cage with two ring-like peripheral elements with end-side trapezoidal recesses which taper axially to the inside for web elements with the correspondingly trapezoidally thickened axial ends in the connected and unconnected state of the elements,

FIGS. 13 and 14 in a perspective view show a cylindrical roller bearing cage with two ring-like peripheral elements and with web elements whose insides are made on the axial ends each with a shoulder for adjoining the outside edge of the peripheral elements, in the connected and unconnected state of the elements,

FIGS. 15 and 16 in a perspective view show a cylindrical roller bearing cage with two ring-like peripheral elements and with web elements whose outsides are made on the axial ends each with a shoulder for adjoining the inside edge of the peripheral elements, in the connected and unconnected state of the elements,

FIG. 17 shows in a perspective view a cylindrical roller bearing cage accordingly to the one in FIG. 2 with additional lubricating pockets in the web elements,

FIG. 18 shows in a perspective view one of the web elements of FIG. 17 and

FIGS. 19 and 20 in a perspective view show a tapered roller bearing cage with two peripheral elements with indentations for web elements with a uniform trapezoidal cross section in the connected and unconnected state of the elements.

### DETAILED DESCRIPTION

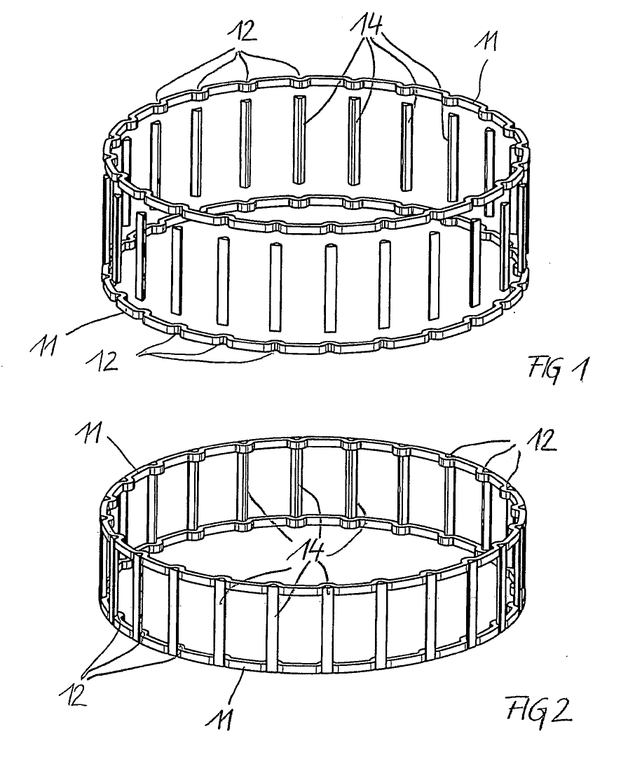

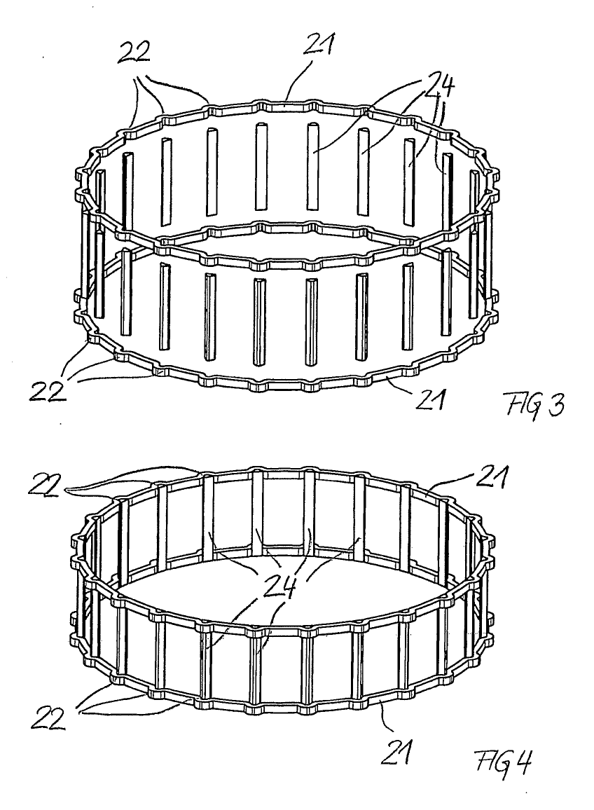

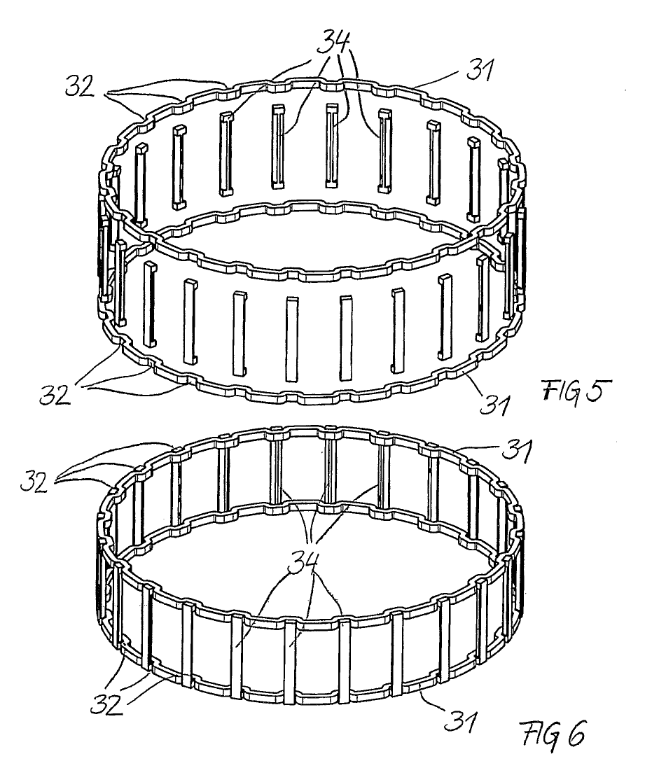

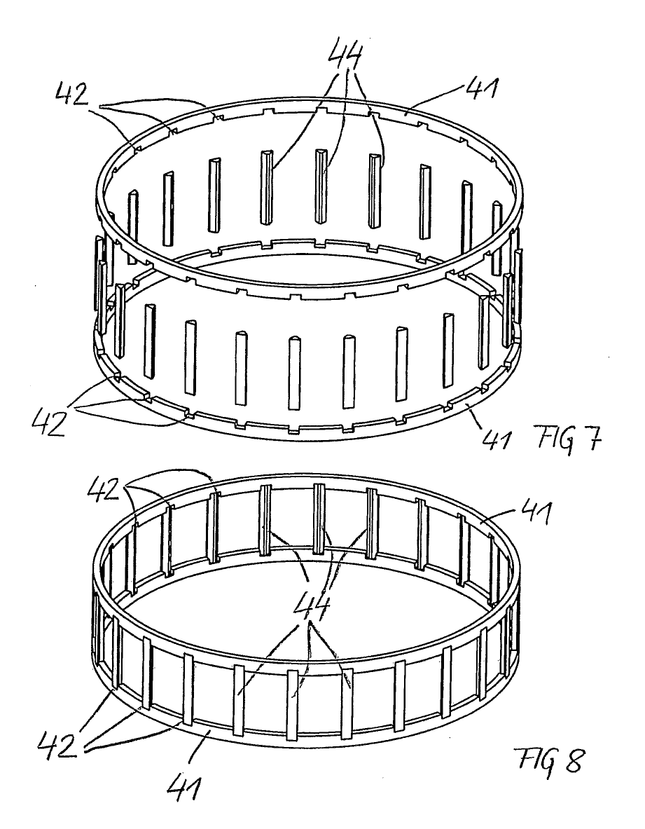

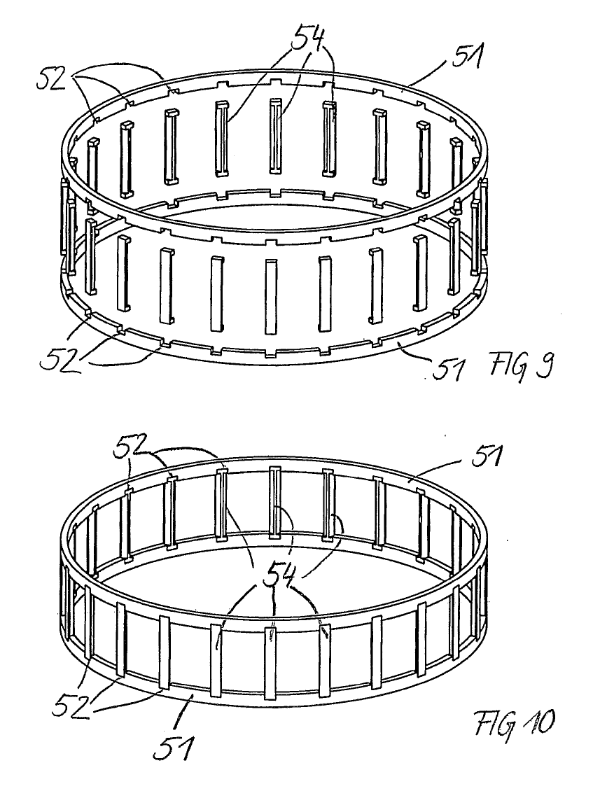

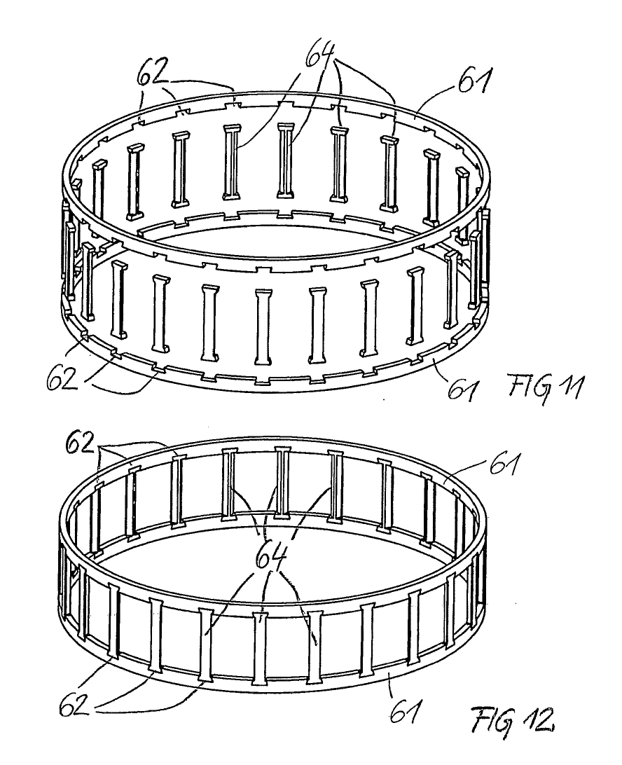

FIGS. 1 and 2 show as one embodiment of the invention in a perspective view a cylindrical roller bearing cage with two peripheral elements 11 with indentations 12 for web elements 14 with a uniform trapezoidal cross section. FIG. 1 shows the cage in the still unconnected state of the elements 11 and 14, and FIG. 2 shows the cage after connecting the elements 11 and 14. Here the indentations 12 on the peripheral elements 11 in conjunction with the web elements 14 shaped according to the indentations 12 when the elements 11 and 14 are assembled for welding of the web elements 14 on the peripheral elements 11 provide for prepositioning of the web elements 14 in the peripheral direction of the peripheral elements 11.

Here the elements 11 and 14 are produced from an iron material, especially from a steel wire. In other embodiments however also other materials can be used and instead of welding also soldering or cementing can be used. Furthermore, especially also the web elements 14 can be made with a coating for achieving a special sliding behavior, especially in the region of their contact surfaces toward the rolling bodies.

FIGS. 3 and 4 show as another embodiment of the invention in a perspective view a cylindrical roller bearing cage with two peripheral elements 21 with bulges 22 for web elements 24 with a uniform trapezoidal cross section. Here FIG. 3 shows the cage in the still unconnected state of the elements 21 and 24 and FIG. 4 shows the cage after connecting the elements 21 and 24. Otherwise what was described above for FIGS. 1 and 2 applies accordingly to the cage of FIGS. 3 and 4 accordingly.

FIGS. 5 and 6 show as another embodiment of the invention in a perspective view a cylindrical roller bearing cage with two peripheral elements 31 with indentations 32 for web elements 34 with axial ends reinforced in the manner of a hammer head. Here FIG. 5 shows the cage in the still unconnected state of the elements 31 and 34 and FIG. 6 shows the cage after connecting the elements 31 and 34. Here the cage of FIGS. 5 and 6 differs from the one of FIGS. 1 and 2 essentially in that the web elements 34 on their axial ends are reinforced in the manner of a hammer head, and also the indentations 32 matched thereto are made accordingly wider, with which an especially large connecting surface between the web elements 34 and the peripheral elements 31 and thus an especially strong connection and stiff execution of the entire cage can be achieved. Otherwise what was described above for FIGS. 1 to 4 applies.

FIGS. 7 and 8 show as another embodiment of the invention in a perspective view a cylindrical roller bearing cage with two ring-like peripheral elements 41 with end-side, rectangle-like recesses 42 for web elements 44 with a uniform trapezoidal cross section. FIG. 7 shows the cage in the still unconnected state of the elements 41 and 44 and FIG. 8 shows the cage after connecting the elements 41 and 44. Here the recesses 42 in the peripheral elements 41 when the web elements 44 are inserted into the peripheral elements 41 provide for welding of the elements 41 and 44 to one another, for prepositioning of the web elements 44 in the peripheral direction, but also in the axial direction of the peripheral elements 41. Differently than in the cages according to FIGS. 1 to 6, thus in the cage as shown in FIGS. 7 and 8 the distance between the two peripheral elements 41 is fixed at the same time since the web elements 44 are inserted so-to-speak between the peripheral elements 41. Otherwise what was described above for FIGS. 1 to 6 applies.

FIGS. 9 and 10 as another embodiment of the invention in a perspective view show a cylindrical roller bearing cage with two ring-like peripheral elements 51 with end-side, rectangle-like recesses 52 for web elements 54 with axial ends reinforced in the manner of a hammer head. FIG. 9 shows the cage in the still unconnected state of the elements 51 and 54 and FIG. 10 shows the cage after connecting the elements 51 and 54. Compared to the cage of FIGS. 7 and 8 the cage as shown in FIGS. 9 and 10 differs essentially by the hammer head-like reinforcements on the axial ends of the web elements 54. Otherwise what was described above for FIGS. 7 to 8 applies accordingly.

FIGS. 11 and 12 as another embodiment of the invention in a perspective view show a cylindrical roller bearing cage with two ring-like peripheral elements 61 with end-side trapezoidal recesses 62 which taper axially to the inside for web elements 64 with the correspondingly trapezoidally thickened axial ends. FIG. 11 shows the cage in the still uninstalled state of the elements 61 and 64 and FIG. 12 shows the cage after connecting the elements 61 and 64. Compared to the cage of FIGS. 9 and 10, the cage as shown in FIGS. 11 and 12 differs essentially by the recesses 62 as well as the ends of the web elements 64, which ends are thickened in the manner of a hammer head, in addition, seen in the peripheral direction, being made trapezoidal, by which especially advantageously after assembly of the elements 61 and 64 the elements 61 and 64 in the axial direction as a result of the positive connection between the axial ends of the web elements 64 and the peripheral elements 61 are held tightly together. After welding of the elements 61 and 64 to one another advantageously an especially securely joined cylindrical roller bearing cage results.

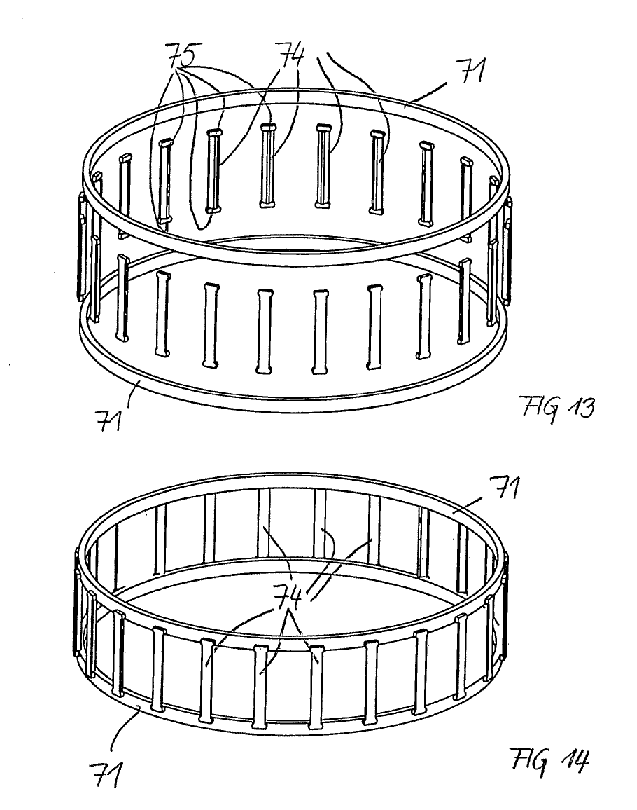

FIGS. 13 and 14 in a perspective view as another embodiment of the invention show a cylindrical roller bearing cage with two ring-like peripheral elements 71 and with web elements 74 whose insides are made on the axial ends each with a shoulder 75 for adjoining the outside edge of the peripheral elements 71. FIG. 13 shows the cage in the still unconnected state of the elements 71 and 74 and FIG. 14 shows the cage after connecting the elements 71 and 74. In the cage as shown in FIGS. 13 to 14, the elements 71 and 74 are shaped only such that the position of the web elements 74 in the axial direction of the peripheral elements 71 is predetermined and thus only the distance of the two peripheral elements 71 to one another is fixed, conversely the correct distribution of web elements 74 in the peripheral direction must be ensured by external measures, for example when the elements 71 and 74 are connected.

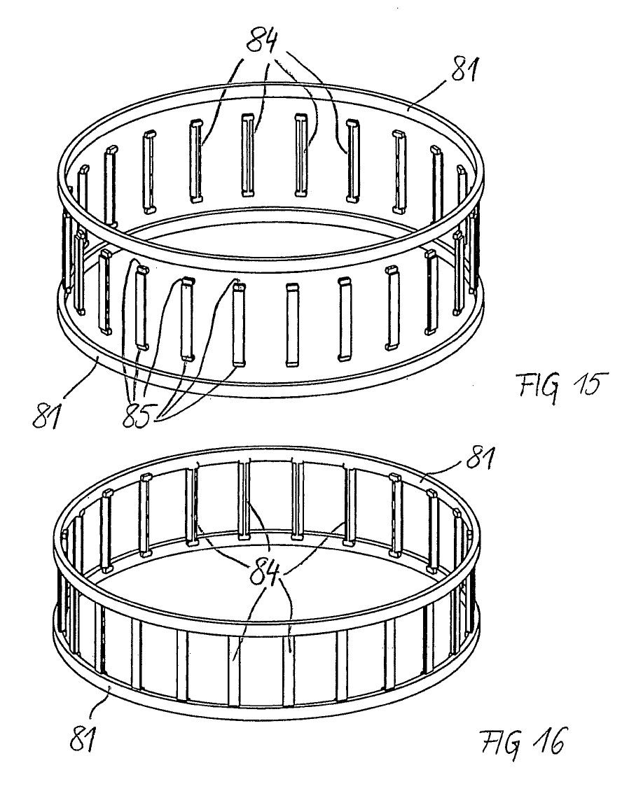

FIGS. 15 and 16 as another embodiment of the invention in a perspective view show a cylindrical roller bearing cage with two ring-like peripheral elements 81 and with web elements 84 whose outsides are now made on the axial ends each with a shoulder 85 for adjoining the inside edge of the peripheral elements 81. FIG. 15 shows the cage in turn in the still unconnected state of the elements 81 and 84 and FIG. 16 shows the cage after connecting the elements 81 and 84. Otherwise what was described above for FIGS. 13 and 14 applies accordingly.

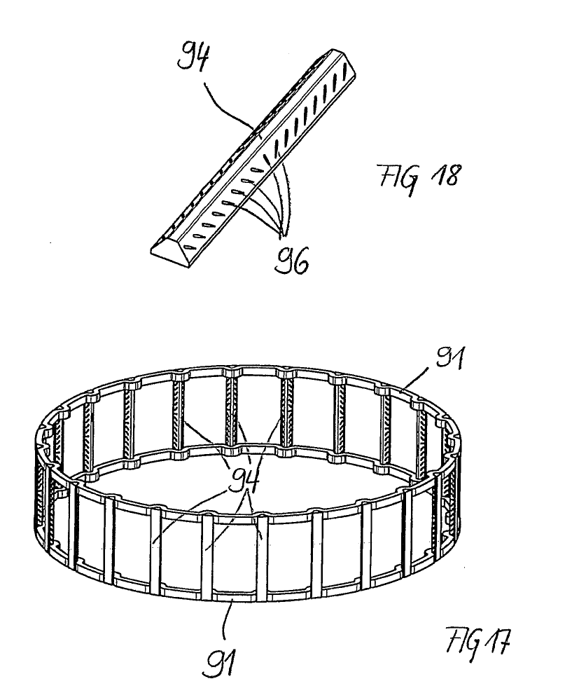

FIG. 17 shows as another embodiment of the invention in a perspective view a cylindrical roller bearing cage with two peripheral elements 91 with indentations for web elements 94 with lubricating pockets 96. Aside from the lubricating pockets 96 the cage of FIG. 17 corresponds to that of FIG. 2. FIG. 18 shows an enlarged perspective representation of one of the web elements 94 with the lubricating pockets 96. The lubricating pockets 96 in the left axial half of the web elements 94 are arranged obliquely, parallel to a line which runs from the right cage area obliquely to the center point of the cage, are made accordingly mirror-inverted in the right half, and one lubricating pocket 96 is radially oriented in the middle. Here the lubricating pockets 96 are made droplet-shaped.

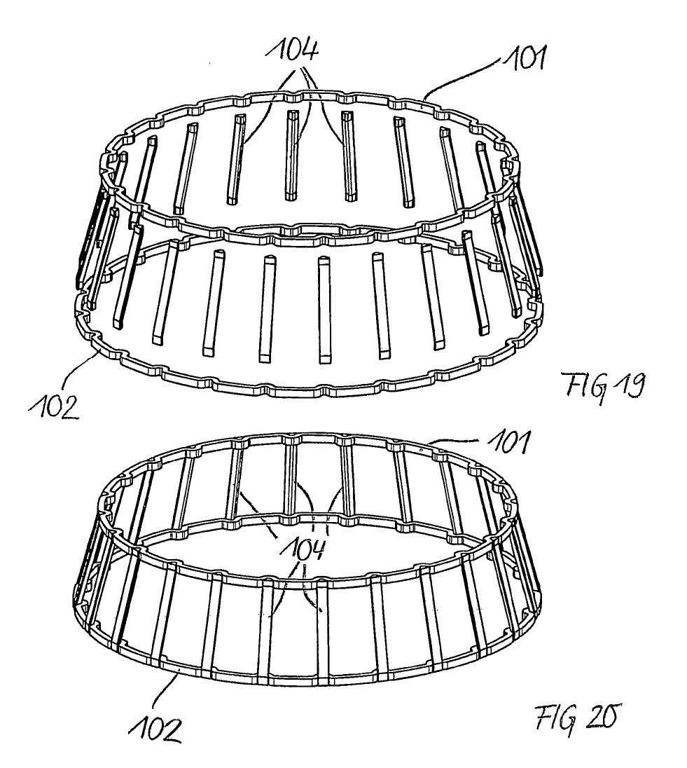

FIGS. 19 and 20 as one embodiment of the invention in a perspective view show a tapered roller bearing cage with two peripheral elements 101 and 102 with indentations for web elements 104 with a uniform trapezoidal cross section. FIG. 19 shows the cage in turn in the still unconnected state of the elements 101, 102 and 104 and FIG. 20 shows the cage after connecting the elements 101, 102 and 104. Aside from the fact that in the cage of FIGS. 19 and 20 the two peripheral elements 101 and 102 are made with different diameters and the web elements 104 are made angled in the transition from their axial ends to their middle area, the cage of FIGS. 19 and 20 corresponds to that of FIGS. 1 and 2. Here what was described otherwise for FIGS. 1 and 2 applies accordingly to the cage for FIGS. 19 and 20. Of course what was stated otherwise for FIGS. 3 to 18 can be applied to a correspondingly made tapered roller bearing cage,

Finally, what was described above for FIGS. 1 to 20 on the example of window cages for a single-row cylindrical or tapered roller radial bearing can also be applied to other roller bearings, for example spherical bearings, CARB bearings and also spherical roller bearings. but also to bearings with comb-like cages, to roller bearings with several rows of rolls and also to thrust bearings.

1. Rolling bearing cage with pockets bordered at least with a U-shaped boundary for rolling bodies, the rolling bearing comprising:
the U-shaped boundary of one of the pockets is formed by a bonded connection of two web elements on a ring-like peripheral element,
the peripheral element is free of cavities and penetrations for a fully peripheral connection to the sections of the web elements, and
for proper positioning of the web elements to one another for a bonded connection, the web elements are made with a shape matched to one another such that the positions of the web elements on the peripheral element are predetermined in a peripheral direction and/or in an axial direction of the peripheral element.

2. Rolling bearing cage as claimed in claim 1, wherein the peripheral element in the peripheral direction is configured with bulges which are made in the radial direction.

3. Rolling bearing cage as claimed in claim 1, wherein the peripheral element includes, in peripheral direction and on one of its end faces, recesses which extend in the axial direction.

4. Rolling bearing cage as claimed in claim 2, wherein the bulges viewed in the peripheral direction are rectangular or trapezoidal.

5. Rolling bearing cage as claimed in claim 1, wherein the web elements include axial end regions which fit into bulges or recesses in the peripheral element.

6. Rolling bearing cage as claimed in claim 1, wherein for positioning purposes at least one axial end of the web elements in the axial direction a shoulder for stopping on an edge area of the peripheral element.

7. Rolling bearing cage as claimed in claim 1, wherein the web elements comprise an iron material and the bonded connection comprises welding.

8. Rolling bearing cage as claimed in claim 7, wherein the bonded connection comprises soldering or cementing.

9. Rolling bearing cage as claimed in claim 1, wherein the peripheral element on the one hand and the web elements on the other are made with different properties.

10. Rolling bearing cage as claimed in claim 1, wherein at least one of the elements is coated at least in partial regions.

11. Rolling bearing cage as claimed in claim 1, wherein at least one of the web elements on its surfaces intended for contact with the rolling bodies includes lubricating pockets.

12. Rolling bearing cage as claimed in claim 1, wherein the cross sectional area of at least one section of one of the web elements is trapezoidal.

13. Rolling bearing cage as claimed in claim 1, wherein the peripheral element is closed in itself or open.

14. Rolling bearing cage as claimed in claim 1, wherein the peripheral element is a first peripheral element and further comprising a second peripheral element, each web element possessing two axial ends, one axial end of each web element being fixed to the first peripheral element and the other axial end of each web member being fixed to the second peripheral element.

15. Rolling bearing cage as claimed in claim 1, wherein pockets which are bordered at least U-shaped and which are made by web elements are axially joined to two end sides of the peripheral element.

16. Rolling bearing cage as claimed in claim 1, wherein the rolling bearing cage is a roller bearing cage.

17. Rolling bearing cage as claimed in claim 3, wherein the recesses viewed in the peripheral direction are rectangular or trapezoidal.

18. Rolling bearing cage with pockets each bordered at least with a U-shaped boundary for rolling bodies, the rolling bearing comprising:
first and second ring-shaped peripheral elements spaced apart in an axial direction and connected to one another by web elements;
the first and second ring-shaped peripheral elements each having an outer periphery extending in a peripheral direction;
each web element having two oppositely disposed axial ends;
the web elements and the first and second ring-shaped peripheral elements being configured to possess matching shapes defining predetermined positions of the web elements on the first and second ring-shaped peripheral elements in at least one of the peripheral direction and the axial direction; and
fixing material fixing the axial ends of each web element to the first and second ring-shaped peripheral elements.

19. Rolling bearing cage as claimed in claim 18, wherein the fixing material comprises a plurality of welds each securing one of the axial ends of the web elements to one of the first and second ring-shaped peripheral elements.
